(19) United States
(12) Patent Application Publication
(10) Pub. No.: US 2009/0076915 A1
(43) Pub. Date: Mar. 19, 2009

(54) Method and system for providing micro-targeted mobile advertisements

(76) Inventor: Martin D. Tighe, Atlanta, GA (US)

Correspondence Address: EDWARDS ANGELL PALMER & DODGE LLP, P.O. BOX 55874, BOSTON, MA, 02205, US

(21) Appl. No.: 12/191,944

(22) Filed: Aug. 14, 2008

Related U.S. Application Data
(60) Provisional application No. 60/964,760, filed on Aug. 14, 2007.

(51) Int. Cl. G06Q 30/00; G01C 21/00

(52) U.S. Cl. 705/14; 701/200

(57) ABSTRACT

The present invention provides methods for providing advertisements using one or more vehicles, which comprise producing an advertisement for a vehicle and selecting a vehicle for the advertisement. The vehicle is selected that has a profile that corresponds to the advertisement profile. The present invention also provide systems and storage media for implementing the methods. With the methods, systems, and/or media, micro-targeted mobile advertising can be provided.

### CROSS-REFERENCE TO RELATED APPLICATION

This application claims the benefit of U.S. Provisional Application No. 60/964,760, filed Aug. 14, 2007, the entire contents of which are incorporated herein by reference.

### TECHNICAL FIELD

The present disclosure relates to a method and system for micro-targeted mobile advertising. More particularly, it relates to a method and system for micro-targeted mobile advertising using one or more vehicles provided with a display.

### BACKGROUND ART

Typically, an advertisement has been to broadcasted to a large number of consumers via mass media such as newspapers, magazines, radio, and television or traditional outdoor advertising stand such as billboards, or bus shelters, etc.

Recently, mobile displays have been proposed as a new advertising medium. For example, as disclosed in U.S. Pat. Nos. 5,717,374; 5,808,565; 5,963,280; 5,878,369; and 6,898,517, advertisements are placed on displays mounted on moving vehicles such as buses, taxicabs, trucks, and the like. One disadvantage associated with the mobile advertisements, however, is an inability to efficiently deliver intended advertising content or message to targeted consumers.

There is thus a need for a method and system that can provide targeted mobile advertisements in a more cost-effective way.

The information disclosed in this Background Art section is only for enhancement of understanding of the background of the invention and should not be taken as an acknowledgement or any form of suggestion that this information forms the prior art that is already known to a person skilled in the art.

### SUMMARY OF THE DISCLOSURE

In one aspect, the present invention provides a method for providing advertisements using one or more vehicles each of the vehicles being provided with a display, the method comprising: producing an advertisement for a vehicle; and selecting a vehicle for the advertisement.

In another aspect, the present invention provides a method for providing micro-targeted advertisements using one or more vehicles each of the vehicles being provided with a display, the method comprising: generating an advertisement based on data received from an advertiser; generating an advertisement profile corresponding to the advertisement based on data received from the advertiser; generating a vehicle profile based on data received from an operator of each vehicle; determining which vehicle has a vehicle profile that matches the advertisement profile; and displaying the advertisement at the display of each vehicle that has been determined to have a vehicle profile that matches the advertisement profile.

In still another aspect, the present invention provides a computer-readable recording medium storing a program for implementing the above-described method.

In a further aspect, the present invention provides a system for providing micro-targeted mobile advertisements, comprising: one or more vehicles, each vehicle being provided with a display; an advertisement propagation unit for generating an advertisement based on data received from an advertiser; an advertisement profile propagation unit for generating an advertisement profile corresponding to the advertisement based on data received from the advertiser; a vehicle profile propagation unit for generating a vehicle profile based on data received from an operator of each vehicle; and a control unit for determining which vehicle has a vehicle profile that matches the advertisement profile and driving to display the advertisement at the display of the vehicle that has been determined to have a vehicle profile that matches the advertisement profile.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum), whether it is private or commercial.

The above and other aspects and features of the invention will be discussed in detail infra.

### BRIEF DESCRIPTION OF THE DRAWINGS

These, and other features and advantages of the invention, will become clear to those skilled in the art from the following detailed description of the preferred embodiments of the invention rendered in conjunction with the appended drawings in which like reference numerals refer to like elements throughout, and in which:

FIG. 1 is a schematic diagram of a system for providing advertisements to targeted consumers according to an embodiment of the present invention.

FIG. 2 is a front view of a display according to an embodiment of the present invention.

FIG. 3 is a side view of the display of FIG. 2.

FIG. 4 is a rear view of the display of FIG. 2.

FIG. 5 is a top view of the display of FIG. 2.

FIG. 6 is a perspective view of a display according to another embodiment of the present invention.

FIG. 7 is an example of advertisement that can be displayed by a system of the present invention.

FIG. 8 is another example of advertisement that can be displayed by a system of the present invention.

FIG. 9 is still another example of advertisement that can be displayed by a system of the present invention.

FIG. 10 is still yet another example of advertisement that can be displayed by a system of the present invention.

FIG. 11 is an example of coupon that can be transmitted by a system of the present invention.

FIG. 12 is a flowchart outlining a method for providing advertisements to targeted consumers according to an embodiment of the present invention.

### DETAILED DESCRIPTION

In one aspect, a method is provided for providing advertisements using one or more vehicles wherein each of the vehicles is provided with a display, the method comprising: producing an advertisement for a vehicle; and selecting a vehicle for the advertisement. Preferably, a vehicle is selected that has a profile that corresponds to the advertisement profile.

In another aspect, a method is provided for providing advertisements using one or more vehicles wherein each of the vehicles is provided with a display, the method comprising: generating an advertisement based on data received from an advertiser; generating an advertisement profile corresponding to the advertisement based on data received from the advertiser; generating a vehicle profile based on data received from an operator of each vehicle; determining which vehicle has a vehicle profile that matches the advertisement profile; and displaying the advertisement at the display of each vehicle that has been determined to have a vehicle profile that matches the advertisement profile.

Preferably, each of the advertisement profile and the vehicle profile may comprise at least one item of vehicle-dependent information, at least one item of vehicle operator-dependent information, or both. The vehicle-dependent information may include, for example, vehicle make (brand), model, color, weight, and height. The vehicle operator-dependent information may include, for example, gender, age, number of vehicles owned or rented, education, marital status, number of children, household income, zip code, number of houses owned or rented, amount of travel, alcohol use, tobacco use, health, physical exercise frequency, restaurant usage style, religion and hobbies.

Suitably, the method may further include detecting vehicle traveling information of each vehicle. Examples of the vehicle traveling information may include a location of the vehicle, a speed of the vehicle, a distance the vehicle has traveled or is anticipated to travel, and a time for which the vehicle has traveled or is anticipated to travel. 7.

In an embodiment, the method may further include charging the advertiser based on time for which the advertisement has been displayed, location at which the advertisement has been displayed, or both. In another embodiment, the method may further include charge the advertiser based on the number of miles the vehicle has been operated with the advertising. In still another embodiment, the method may further include crediting the vehicle operator based on time for which the advertisement has been displayed, location at which the advertisement has been displayed, or both. In a further embodiment, the method may further include crediting the vehicle operator based on the number of miles the vehicle has been operated with the advertising.

Preferably, the method may further include updating at least one of the vehicle profile, the advertisement, and the advertisement profile. The updating can be performed manually, automatically, or both. Also, the updating can be performed at a regular or irregular interval.

Suitably, the method may further include transmitting information to a communication device near one or more of the vehicles. Examples of the communication device may include, but not limited to, a wireless communication device, a Bluetooth device, an Internet device, a telephone device, a portable computing device, a personal digital assistant and a pager. Examples of the information to be transmitted may include, but not limited to, directions, coupons, web links, and click-to-call. Preferably, the information may include, for example, printed image, visual data, audio data and any combination thereof.

Preferably, the method may further include having the vehicle operator provide advertising materials to on-site-consumers. The vehicle operator can provide advertising materials to potential consumers in, for examples, universities, elementary/middle/high schools, airports, churches, workouts (e.g., yoga, spin class), school carpool lines, parks, neighborhoods, offices, restaurants, professional sporting events, etc.

Although the form of the display is not limited, suitable examples of the display may include, but not limited to, liquid crystal, LED, gas plasma, electronic ink, electronic paper, cathode ray tube display and poster-type billboard. In an embodiment, a part or all of video display with latitudinal and/or longitudinal advertisements bid using a Google model may be used.

Likewise, although the form of the advertisement to be displayed is not limited, preferable examples thereof may include, for example, printed image, visual data, audio data and any combination thereof.

In still another aspect, computer-readable recording medium is provided for storing a program for implementing the above-described and equivalent methods.

The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

In a further aspect, a system is provided for providing micro-targeted mobile advertisements. The system may comprise one or more vehicles, an advertisement propagation unit, an advertisement profile propagation unit, a vehicle profile propagation unit, and a control unit.

Each of the one or more vehicles is provided with a display. The advertisement propagation unit generates an advertisement based on data received from an advertiser. The advertisement profile propagation unit generates an advertisement profile corresponding to the advertisement based on data received from the advertiser. The vehicle profile propagation unit generates a vehicle profile based on data received from an operator of each vehicle. The control unit determines which vehicle has a vehicle profile that matches the advertisement profile and drives to display the advertisement at the display of the vehicle that has been determined to have a vehicle profile that matches the advertisement profile.

Preferably, the advertisement profile and the vehicle profile each may comprise at least one item of vehicle-dependent information, at least one item of vehicle operator-dependent information, or both. The vehicle-dependent information may include, for example, vehicle make (brand), model, color, weight, and height. The vehicle operator-dependent information may include, for example, gender, age, number of vehicles owned or rented, education, marital status, number of children, household income, zip code, number of houses owned or rented, amount of travel, alcohol use, tobacco use, health, physical exercise frequency, restaurant usage style, religion and hobbies.

Preferably, the system may further include a vehicle traveling information detecting unit for detecting vehicle traveling information. Non-limiting examples of the information may include a location of the vehicle, a speed of the vehicle, a distance the vehicle has traveled or is anticipated to travel, and a time for which the vehicle has traveled or is anticipated to travel. The vehicle traveling information detecting unit is not limited to a specific form. It may be, for example, a speedometer, a satellite positioning system, or any combination thereof. One of the satellite positioning systems is a GPS.

In an embodiment, the control unit may charge the advertiser on the basis of time for which the advertisement has been displayed, location at which the advertisement has been displayed, or both. In another embodiment, the control unit may charge the advertiser based on the number of miles the vehicle operated with the advertising. In still another embodiment, the control unit may credit the vehicle operator based on time for which the advertisement has been displayed, location at which the advertisement has been displayed, or both. In a further embodiment, the control unit may credit the vehicle operator based on the number of miles the vehicle operated with the advertising.

Preferably, the control unit may update at least one of the vehicle profile, the advertisement, and the advertisement profile. The updating can be performed manually, automatically, or both. Also, the updating can be performed at a regular or irregular interval.

Suitably, the system may further include transmitting unit for transmitting information to a communication device near one or more of the vehicles. Examples of the communication device may include, but not limited to, a wireless communication device, a Bluetooth device, an Internet device, a telephone device, a portable computing device, a personal digital assistant and a pager. Examples of the information to be transmitted may include, but not limited to, directions, coupons, web links, and click-to-call. Preferably, the information may include, for example, printed image, visual data, audio data and any combination thereof.

Although the form of the display is not limited, suitable examples of the display may include, but not limited to, liquid crystal, LED, gas plasma, electronic ink, electronic paper, cathode ray tube display and poster-type billboard. In an embodiment, a part or all of video display with latitudinal and/or longitudinal advertisements bid using a Google model may be used. Likewise, although the form of the advertisement to be displayed is not limited, preferable examples thereof may include, for example, printed image, visual data, audio data and any combination thereof.

In a yet further aspect, the invention includes use of such methods with a private or non-commercial group of vehicles, e.g. vehicles that are owned by private individuals (such as commuters to other employment, homemakers, etc.) and who do not utilize their vehicles (e.g. automobile or truck) for commercial transport of passengers or goods. Thus, such non-commercial vehicles do not include taxis, commercial limousines, commercial trucks and the like. It should be understood that although private or non-commercial group of vehicles are preferred, commercial group of vehicles can also be used.

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

### System

As discussed above, a first aspect of the present invention provides systems for providing micro-targeted mobile advertisements. Broadly stated, the present system comprises: one or more vehicles, each of the vehicles being provided with a display; an advertisement propagation unit for generating an advertisement based on data received from an advertiser; an advertisement profile propagation unit for generating, based on data received from the advertiser, an advertisement profile corresponding to the advertisement; a vehicle profile propagation unit for generating a vehicle profile based on data received from an operator of each vehicle; and a control unit for determining which vehicle has a vehicle profile that matches the advertisement profile and driving to display the advertisement at the display of the vehicle that has been determined to have a vehicle profile that matches the advertisement profile.

Preferably, the advertisement propagation unit, the advertisement profile propagation unit, the vehicle profile propagation unit, and the control unit can be located in or on each vehicle. At least one of these units, however, can be located at a place separate from the vehicle, e.g., as a separate server. As explained below, those units are operatively coupled for providing micro-targeted advertising.

The present systems may include a wireless communication system for transmitting and receiving wireless message to and from each unit. The wireless communication system may comprise a two-way radio system, a cellular telephone system, a cordless telephone system, a home wireless network, a personal communication system (PCS), a personal area network (e.g., a Bluetooth network), a wireless data system (e.g., palmtop computers, PDAs, or laptop computers with PCMCIA cards), a paging system or any combination thereof.

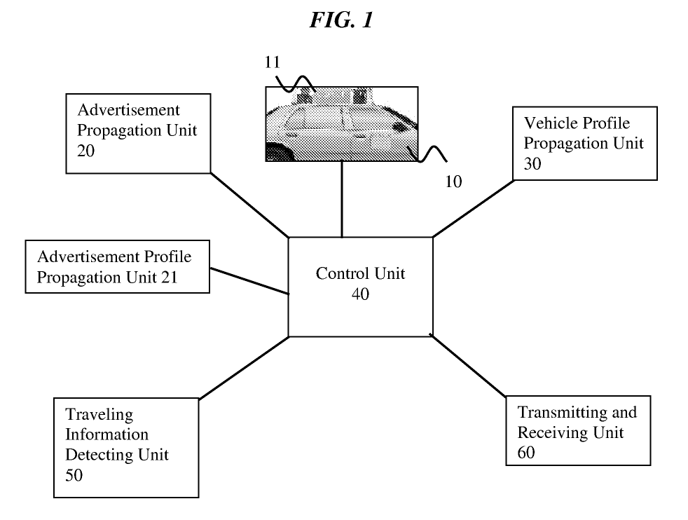

FIG. 1 is a schematic diagram of a system according to a preferred embodiment of the present invention. Although one vehicle 10 is described in FIG. 1, the system includes one ore more vehicles. Each vehicle 10 is provided with a display 11. The term “vehicle” or other similar term as used herein is inclusive of motor vehicles in general such as motorcycles, passenger automobiles including sports utility vehicles (SUV), taxicabs, buses, trucks, various personal, commercial or government vehicles, watercraft including a variety of boats and ships, aircraft, and the like.

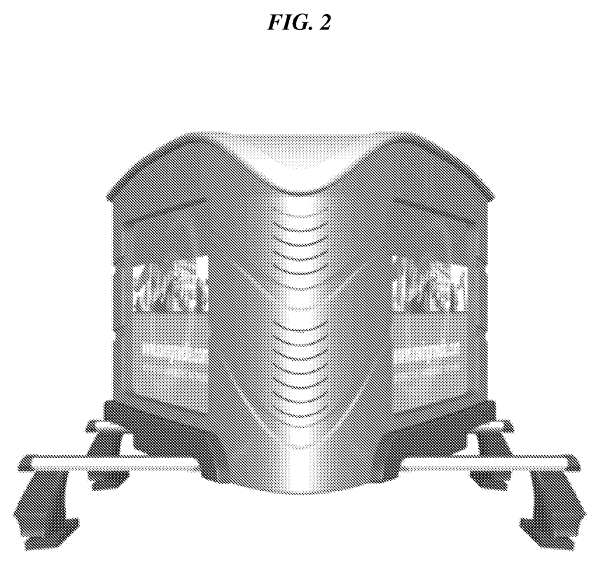

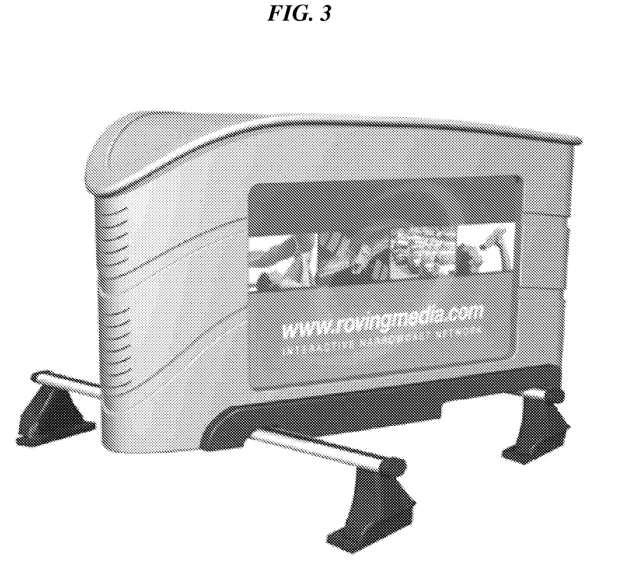

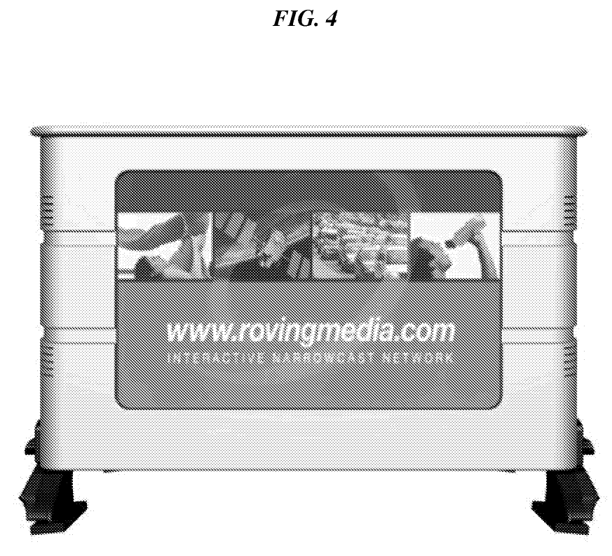

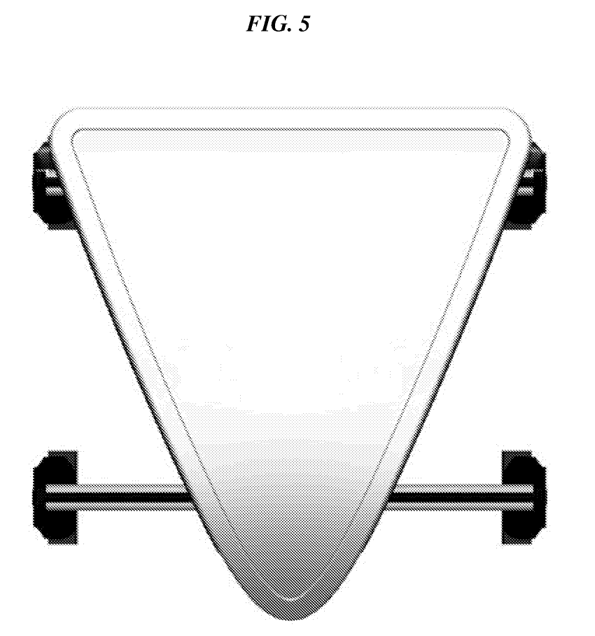

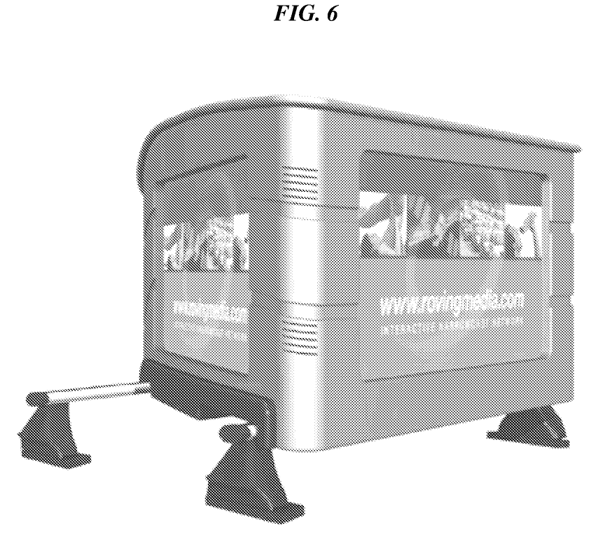

The display 11 can have many different types and sizes, depending on, for example, characteristic of the vehicle 10 to which the display 11 is mounted, as exemplified in FIGS. 2-6. The display 11 can be virtually any type of display that can show an electronically encoded messages or images. Examples of the display 11 include, but not limited to, a billboard type device, a liquid crystal, an LED, a gas plasma, an electronic ink, an electronic paper, a cathode ray tube display, or the like. The display 11 can be mounted at various locations relative to the vehicle 10.

Referring to FIG. 1, the system includes an advertisement propagation unit 20 adapted to generate an advertisement based on data received from an advertiser. Also, the system also includes an advertisement profile propagation unit 21 adapted to generate, based on data received from the advertiser, an advertisement profile corresponding to the advertisement. The advertisement propagation unit 20 can be integrated with the advertisement profile propagation unit 21 as a single unit. Alternatively, they can be provided separately. In addition, the system includes a vehicle profile propagation unit 30 adapted to generate a vehicle profile based on data received from an operator of each vehicle.

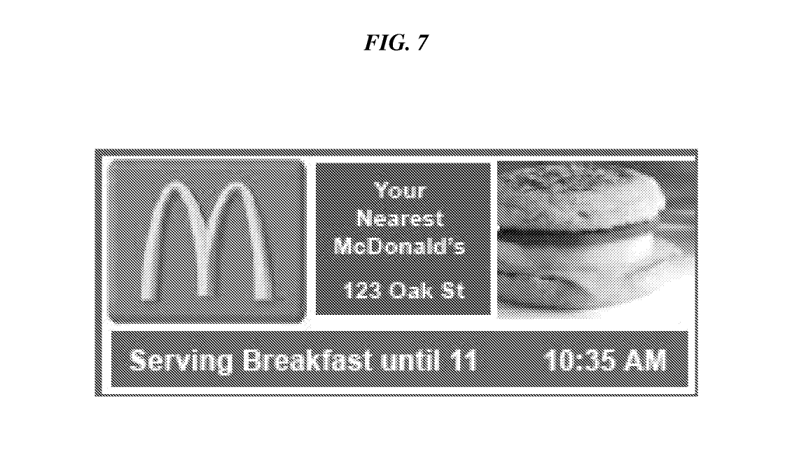

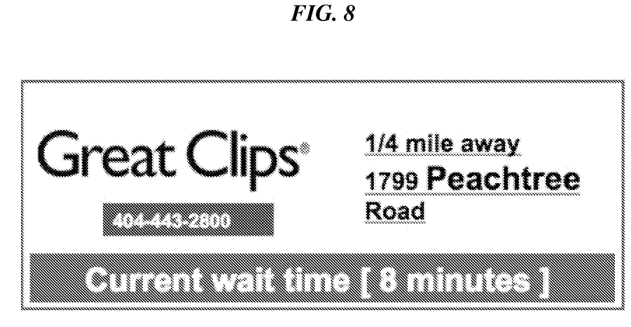

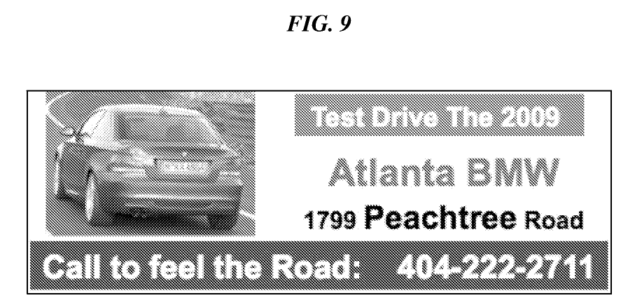

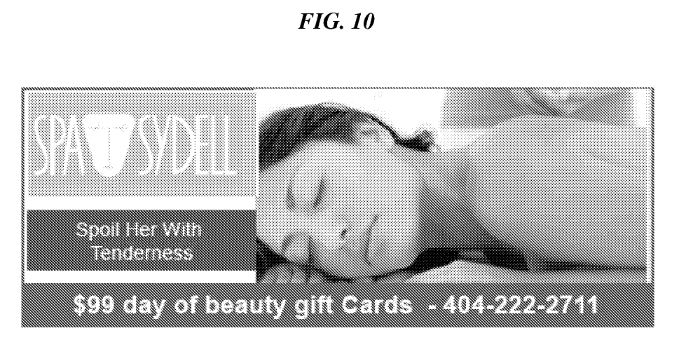

The advertisement can have various forms of contents and messages, as exemplified in FIGS. 7-10. The content can be, for instance, from simple text messages to graphic, animated or video images. It can include visual information, audio information, or both. If it includes audio information, one or more controllable speakers can be provided in/on the vehicle or the display. Further, it should be understood that although the content preferably includes advertising information, it can include non-advertising information, such as news or weather information.

The advertisement profile and the vehicle profile each includes at least one item of vehicle-dependent information and/or at least one of vehicle operator-dependent information. The vehicle-dependent information may be associated with type of vehicle, including, for example, vehicle make (brand), model, color, weight, and height. The vehicle operator-dependent information may be associated with operator's lifestyles, habits, pleasures, hobbies, etc. For example, the vehicle operator-dependent information can include, but not limited to, gender, age, number of vehicles owned or rented, education, marital status, number of children, household income, zip code, number of houses owned or rented, amount of travel, alcohol use, tobacco use, health, physical exercise frequency, restaurant usage style, religion and hobbies.

To match vehicle brand and lifestyle of the vehicle operators with those of consumers based on the vehicle-dependent and vehicle operator-dependent information, as explained in detail below, would enable an advertiser to micro-target its mobile advertisement to consumers (audiences/viewers) in a highly cost-effective way.

An advertiser can provide data necessary for generating an advertisement and an advertisement profile by an on-line or off-line command, e.g., by conventional mail, facsimile or other similar means, or via a message sent from the Internet, from a phone, or from a wireless device such as an i-phone or a PDA. Likewise, a vehicle operator or owner can provide data necessary for generating a vehicle profile in the same or similar way. Based on the information, the advertisement profile propagation unit 20 and the vehicle profile propagation unit 21 generate the advertisement profile and the vehicle profile, respectively.

The system also includes a control unit 40. Preferably, the control unit 40 is a general-purpose computer. It can be any type of device that can execute instructions contained in one or more software programs. The control unit 40 can be integrated with at least one of the other units, e.g., the advertisement propagation unit 20, advertisement profile propagation unit 21, vehicle profile propagation unit 30, vehicle traveling information detecting unit 50, and a transmitting or receiving unit 60, as a single unit. Alternatively, it can be coupled with one or more of those units as a separate unit. Also, the control unit 40, as a general-purpose computer does, can be coupled to at least one of a power source, an input device, an output device, and any other type of communication device (not shown in FIG. 1).

The control unit 40 performs many functions. One function is to determine which vehicle has a vehicle profile that matches an advertisement profile. Determination of whether a vehicle profile matches a given advertisement profile can be made by manually or automatically. For example, the control unit 40 allows an advertiser to select one or more items to be used in selecting one or more vehicles at the display(s) of which the advertiser's advertisement is to be shown. Alternatively, the control unit 40 uses an optimization scheme to automatically select one or more items which best match a given advertiser's advertisement profile.

If the control unit 40 determines a vehicle to have a vehicle profile that matches the advertisement profile, the control unit drives the display of the vehicle to display the corresponding advertisement.

Another function of the control unit 40 is to charge the advertiser and/or credit the vehicle operator based, at least in part, on the vehicle traveling information. For example, the advertiser may be charged on the basis of the time for which the advertisement is displayed and the location at which the advertisement is displayed. Similarly, the vehicle operator may be charged on the basis of the time for which the advertisement is displayed and the location at which the advertisement is displayed. Otherwise, they also may be charged on the basis of, for example, the number of miles the vehicle operated with the advertising.

Yet another function of the control unit 40 is to update at least one of the vehicle profile, the advertisement, and the advertisement profile. Preferably, the updating can be performed either manually or automatically. Also, the updating can be performed at a regular or irregular interval. For example, the updating can be performed periodically or upon a change in at least one of the vehicle profile, the advertisement, and the advertisement profile.

The system according to the preferred embodiment may further include a detecting unit 50 for detecting vehicle traveling information. Examples of the vehicle traveling information include, but not limited to, a location of the vehicle, a speed of the vehicle, a distance the vehicle traveled or is anticipated to travel, and a time for which the vehicle traveled or is anticipated to travel. Preferably, the vehicle traveling information detecting unit 50 can be any type of currently or hereafter known device capable of detecting such vehicle traveling information. Preferable examples of the vehicle traveling information detecting unit 50 may be a speedometer, a satellite positioning system, or combination thereof. Suitably, the satellite positioning system is a GPS.

The vehicle traveling information detecting unit 50 can be located in/on the vehicle or at a place separate from the vehicle. For example, the location of a given vehicle can be sensed by a device located in the vehicle or by a network of wireless receivers separate from the vehicle. The speed of the vehicle can be sensed by equipment located in/on the vehicle, such as a speedometer or GPS equipment, or by tracking the change of the vehicle's location over time.

The system according to the preferred embodiment further includes a transmitting unit 60 for transmitting information to a communication device in the vicinity of the vehicle 10. The transmitting unit 60 can be any type of device capable of performing such transmission. Preferably, it can be a wireless transmission system. The communication device can be any type of device capable of performing such communication. Non-limiting examples of the communication device include: (i) a wireless communication device, (ii) a Bluetooth device, (iii) an Internet device, (iv) a telephone device, (v) a portable computing device, (vi) a personal digital assistant (PDA), and (vii) a pager.

Likewise, the transmitting unit 60 can be located in/on the vehicle or at a place separate from the vehicle 10.

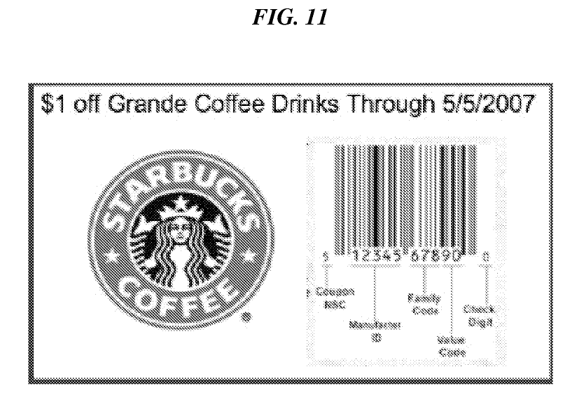

Preferably, the information to be transmitted may include directions, coupons (as shown in FIG. 11), offers web links, lick to call, and combination thereof. Also preferably, the information may include visual data and/or audio data.

### System Operation

Another aspect of the present invention provides methods for providing micro-targeted advertisements using one or more vehicles each of the vehicles being provided with a display. The present methods, broadly stated, comprise the steps of: generating and advertisement based on data received from an advertiser; generating, based on data received from the advertise, an advertisement profile corresponding to the advertisement; generating a vehicle profile based on data received from an operator of each vehicle; determining which vehicle has a vehicle profile that matches the advertisement profile; and displaying the advertisement at the display of each vehicle that has been determined to have a vehicle profile that matches the advertisement profile.

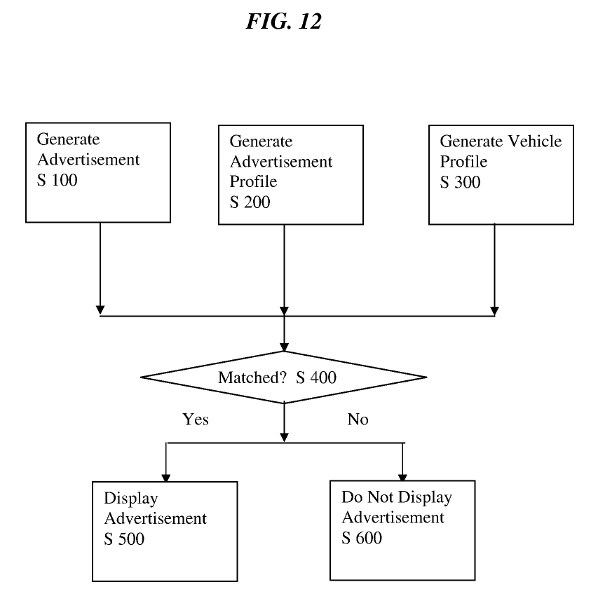

FIG. 12 is a flowchart of the steps in a method for providing micro-targeted mobile advertisements in accordance with a preferred embodiment of the present invention. While the steps described herein and illustrated in the flowchart contain many specific examples of information and media flow, these steps should not be construed as limitations on the scope of the invention, but rather as examples of steps that could be used to practice the invention. Also, FIG. 12 cannot be interpreted to limit the order of the steps. Terms that have been defined above with regard to the systems will not be discussed here.

In step 100 of FIG. 12, based on data received from an advertiser, an advertisement is generated. In step 200, based on data received from the advertiser, an advertisement profile corresponding to the advertisement is generated. In step 300, based on data received from an operator of a vehicle, a vehicle profile is generated. These steps can be performed in series or simultaneously. When the steps are performed in series, no specific order of the steps is required.

In step 400, once at least advertisement profile and vehicle profile are generated, determination of which vehicle has a vehicle profile that matches the advertisement profile desired by an advertiser is made.

In step 500, if one or more vehicles have vehicle profiles that match the advertisement profile, the advertisement generated in step 100 is displayed at the display of each of the vehicles. If no matched profiles exist, no advertisement or default advertisement or message is displayed (step 600).

In a preferred embodiment, the method may further include the step of detecting vehicle traveling information including, for example, a location of the vehicle, a speed of the vehicle, a distance the vehicle traveled or is anticipated to travel, and a time for which the vehicle traveled or is anticipated to travel.

In another preferred embodiment, the method may further include the step of charging the advertiser and/or crediting the vehicle operator based, at least in part, on the vehicle traveling information, e.g., the time for which the advertisement is displayed and the location at which the advertisement is displayed, or the number of miles the vehicle operated with the advertising.

In still another preferred embodiment, the method may further include the step of updating at least one of the vehicle profile, the advertisement, and the advertisement profile manually, automatically, regularly, or irregularly.

In yet another preferred embodiment, the method may further comprise the step of transmitting information to a communication device near the vehicle. Preferably, the information to be transmitted may include directions, coupons, offers web links, click to call, and combination thereof.

In a further preferred embodiment, the method may further comprise the step of having a vehicle operator provides advertising materials to on-site-consumers. For example, the vehicle operator can participate a guerilla marketing campaign. It can also provide, for instance, product samples, coupons, and the like. In a preferred embodiment, the vehicle operator who provides such services to on-site-consumers can be credited by, for example, gasoline voucher, cash, and the like.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for providing micro-targeted advertisements using one or more vehicles each of the vehicles being provided with a display, the method comprising:
(a) generating an advertisement based on data received from an advertiser;
(b) generating an advertisement profile corresponding to the advertisement based on data received from the advertiser;
(c) generating a vehicle profile based on data received from an operator of each vehicle;
(d) determining which vehicle has a vehicle profile that matches the advertisement profile; and
(e) displaying the advertisement at the display of each vehicle that has been determined to have a vehicle profile that matches the advertisement profile.

2. The method of claim 1, wherein the advertisement profile and the vehicle profile each comprise at least one item of vehicle-dependent information, at least one item of vehicle operator-dependent information, or both.

3. The method of claim 2, wherein the vehicle-dependent information is at least one selected from the group comprising vehicle make (brand), model, color, weight, and height.

4. The method of claim 2, wherein the vehicle operator-dependent information is at least one selected from the group comprising gender, age, number of vehicles owned or rented, education, marital status, number of children, household income, zip code, number of houses owned or rented, amount of travel, alcohol use, tobacco use, health, physical exercise frequency, restaurant usage style, religion and hobbies.

5. The method of claim 1, further comprising detecting vehicle traveling information of each vehicle.

6. The method of claim 5, wherein the vehicle traveling information is at least one selected from the group comprising a location of the vehicle, a speed of the vehicle, a distance the vehicle has traveled or is anticipated to travel, and a time for which the vehicle has traveled or is anticipated to travel.

7. The method of claim 6, further comprising charging the advertiser based on time for which the advertisement has been displayed, location at which the advertisement has been displayed, or both.

8. The method of claim 6, further comprising charging the advertiser based on the number of miles the vehicle has been operated with the advertising.

9. The method of claim 6, further comprising crediting the vehicle operator based on time for which the advertisement has been displayed, location at which the advertisement has been displayed, or both.

10. The method of claim 6, further comprising crediting the vehicle operator based on the number of miles the vehicle has been operated with the advertising.

11. The method of claim 1, further comprising updating at least one of the vehicle profile, the advertisement, and the advertisement profile.

12. The method of claim 11, wherein the updating is performed manually or automatically.

13. The method of claim 1, further comprising transmitting information to a communication device near one or more of the vehicles.

14. The method of claim 13, wherein the communication device is at least one selected from the group comprising: (i) a wireless communication device, (ii) a Bluetooth device, (iii) an Internet device, (iv) a telephone device, (v) a portable computing device, (vi) a personal digital assistant (PDA), and (vii) a pager.

15. The method of claim 13, wherein the information to be transmitted is at least one selected from the group comprising directions, coupons, web links, and click-to-call.

16. The method of claim 13, wherein the information comprises printed image, electronic visual data, electronic audio data and any combination thereof.

17. The method of claim 1, further comprising having the vehicle operator provide advertising materials to on-site-consumers.

18. The method of claim 1, wherein the display is at least one selected from the group comprising liquid crystal, LED, gas plasma, electronic ink, electronic paper, cathode ray tube display and poster-type billboard.

19. The method of claim 1, wherein the advertisement to be displayed in the display comprises printed image, electronic visual data, electronic audio data and any combination thereof.

20. The method of claim 1, wherein the vehicle is a non-commercial vehicle.

21. The method of claim 1, wherein the vehicle is an automobile or truck owned by a private individual.

22. A method for providing advertisements using one or more vehicles each of the vehicles being provided with a display, the method comprising:
(a) producing an advertisement for a vehicle; and
(b) selecting a vehicle for the advertisement.

23. The method of claim 22, wherein the vehicle is selected that has a profile that corresponds to the advertisement profile.

24. The method of claim 22, wherein the vehicle is a non-commercial vehicle.

25. The method of claim 22, wherein the vehicle is an automobile or truck owned by a private individual.

26. A computer-readable recording medium storing a program for implementing the method according to claim 1.

27. A system for providing micro-targeted mobile advertisements, comprising:
(a) one or more vehicles, each vehicle being provided with a display;
(b) an advertisement propagation unit for generating an advertisement based on data received from an advertiser;
(c) an advertisement profile propagation unit for generating an advertisement profile corresponding to the advertisement based on data received from the advertiser;
(d) a vehicle profile propagation unit for generating a vehicle profile based on data received from an operator of each vehicle; and
(e) a control unit for determining which vehicle has a vehicle profile that matches the advertisement profile and driving to display the advertisement at the display of the vehicle that has been determined to have a vehicle profile that matches the advertisement profile.

28. The system of claim 27, wherein the advertisement profile and the vehicle profile each comprise at least one item of vehicle-dependent information, at least one item of vehicle operator-dependent information, or both.

29. The system of claim 28, wherein the vehicle-dependent information is at least one selected from the group comprising vehicle make (brand), model, color, weight, and height.

30. The system of claim 28, wherein the vehicle operator-dependent information is at least one selected from the group comprising gender, age, number of vehicles owned or rented, education, marital status, number of children, household income, zip code, number of houses owned or rented, amount of travel, alcohol use, tobacco use, health, physical exercise frequency, restaurant usage style, religion and hobbies.

31. The system of claim 27, further comprising a vehicle traveling information detecting unit for detecting at least one selected from the group comprising a location of the vehicle, a speed of the vehicle, a distance the vehicle has traveled or is anticipated to travel, and a time for which the vehicle has traveled or is anticipated to travel.

32. The system of claim 31, wherein the vehicle traveling information detecting unit is a speedometer, a satellite positioning system, or combination thereof.

33. The system of claim 32, wherein the satellite positioning system is a GPS.

34. The system of claim 31, wherein the control unit charges the advertiser based on time for which the advertisement has been displayed, location at which the advertisement has been displayed, or both.

35. The system of claim 31, wherein the control unit charges the advertiser based on the number of miles the vehicle operated with the advertising.

36. The system of claim 31, wherein the control unit credits the vehicle operator based on time for which the advertisement has been displayed, location at which the advertisement has been displayed, or both.

37. The system of claim 31, wherein the control unit credits the vehicle operator based on the number of miles the vehicle operated with the advertising.

38. The system of claim 27, wherein the control unit updates at least one of the vehicle profile, the advertisement, and the advertisement profile.

39. The system of claim 38, wherein the updating is performed manually or automatically.

40. The system of claim 27, further comprising a transmitting unit for transmitting information to a communication device near one or more of the vehicles.

41. The system of claim 40, wherein the communication device is at least one selected from the group comprising: (i) a wireless communication device, (ii) a Bluetooth device, (iii) an Internet device, (iv) a telephone device, (v) a portable computing device, (vi) a personal digital assistant (PDA), and (vii) a pager.

42. The system of claim 40, wherein the information to be transmitted is at least one selected from the group comprising directions, coupons, web links, and click-to-call.

43. The system of claim 40, wherein the information comprises printed image, electronic visual data, electronic audio data, or any combination thereof.

44. The system of claim 27, wherein the display is at least one selected from the group comprising liquid crystal, LED, gas plasma, electronic ink, electronic paper, and cathode ray tube display and billboard type poster.

45. The system of claim 27, wherein the advertisement to be displayed in the display comprises printed image, electronic visual data, electronic audio data, or any combination thereof.
